(19) United States
(12) Patent Application Publication
(10) Pub. No.: US 2016/0125995 A1
(43) Pub. Date: May 5, 2016

(54) ARRAY OF INTERLEAVED 8-SHAPED TRANSFORMERS WITH HIGH ISOLATION BETWEEN ADJACENT ELEMENTS

(71) Applicant: QUALCOMM INCORPORATED, San Diego, CA (US)

(72) Inventors: Miena ARMANIOUS, La Jolla, CA (US); Darryl JESSIE, San Diego, CA (US); Thomas Andrew MYERS, San Diego, CA (US)

(21) Appl. No.: 14/530,068

(22) Filed: Oct. 31, 2014

(51) Int. Cl. H01F 19/00; H01F 17/00

(52) U.S. Cl. CPC H01F 19/00; H01F 17/0006; H01F 2017/0073

(57) ABSTRACT

An apparatus configured to isolate a direct current component voltage of a first circuit from a direct current component voltage of a second circuit in which the apparatus includes a first conductor and a second conductor. The first conductor has a first portion disposed to substantially enclose a first area, a second portion disposed within the first area, a third portion disposed to substantially enclose a second area, and a fourth portion disposed within the second area, the second area lacking an intersection with the first area. The second conductor is configured to be magnetically coupled to the first conductor and has a fifth portion disposed between the first portion and the second portion and a sixth portion disposed between the third portion and the fourth portion.

### BACKGROUND

1. Field

Aspects of this disclosure generally relate to a transformer in which each of a first conductor and a second conductor has a shape that resembles a symbol for the number eight (i.e., 8) and the second conductor is disposed between a first section of the first conductor and a second section of the first conductor.

2. Description of the Related Art

The reduction in feature sizes of active devices has enabled more of them to be fabricated on an integrated circuit chip. This evolution has made area on a chip available to accommodate the fabrication of more complex circuits that include both active and passive devices even though some passive devices, for example, inductors and transformers, must be spaced sufficiently apart from one another to prevent problems associated with undesired magnetic coupling between them. More recently, technology standards for wireless networks, in order to increase data rates, have adopted an approach known as carrier (or channel) aggregation in which data is transmitted over several channels. Implementations of this approach can require equipment that uses several transceivers and power amplifiers, which in turn can involve the use of several transformers. The increase in the need for on-chip transformers, and the area these devices consume, presents a limitation on the number of devices that can be fabricated on a chip.

### SUMMARY

Features and utilities of the disclosure can be achieved by providing an apparatus configured to isolate a direct current component voltage of a first circuit from a direct current component voltage of a second circuit. The apparatus can include a first conductor and a second conductor. The first conductor can have a first portion disposed to substantially enclose a first area, a second portion disposed within the first area, a third portion disposed to substantially enclose a second area, and a fourth portion disposed within the second area. The second area can lack an intersection with the first area. The second conductor can be configured to be magnetically coupled to the first conductor and can have a fifth portion disposed between the first portion and the second portion and a sixth portion disposed between the third portion and the fourth portion.

Features and utilities of the disclosure can also be achieved by providing an apparatus configured to isolate a direct current component voltage of a first circuit from a direct current component voltage of a second circuit. The apparatus can include a first conductor and a second conductor. The first conductor can have a first portion disposed to substantially enclose a first area, a second portion disposed within the first area, a third portion disposed to substantially enclose a second area, and a fourth portion disposed within the second area. The second area can lack an intersection with the first area. The first conductor can be configured so that a current that flows through the first conductor produces a first magnetic field having a first direction in the first area and a second magnetic field having a second direction in the second area. The second conductor can be configured to be magnetically coupled to the first conductor.

Features and utilities of the disclosure can also be achieved by providing an apparatus configured to isolate a direct current component voltage of a first circuit from a direct current component voltage of a second circuit. The apparatus can include a first conductor and a second conductor. The first conductor can have a first portion disposed to substantially enclose a first area, a second portion disposed within the first area, a third portion disposed to substantially enclose a second area, and a fourth portion disposed within the second area. The second area can lack an intersection with the first area. The second conductor can be configured to be magnetically coupled to the first conductor and can be configured so that a current that flows through the second conductor produces a first magnetic field having a first direction in the first area and a second magnetic field having a second direction in the second area.

Features and utilities of the disclosure can also be achieved by providing an apparatus configured to isolate a direct current component voltage of a first circuit from a direct current component voltage of a second circuit. The apparatus can include a first conductor and a second conductor. The first conductor can have a first section disposed to substantially enclose an area and to cross from a first side of the area to a second side of the area substantially at a center of the area and a second section disposed within the area and to cross from the first side to the second side substantially at the center. The second conductor can be disposed between the first section and the second section and to cross from the first side to the second side substantially at the center and can be configured to be magnetically coupled to the first conductor.

### BRIEF DESCRIPTION OF THE DRAWINGS

These and other sample aspects of the disclosure are described in the detailed description and the claims that follow, and in the accompanying drawings.

FIG. 1 is a diagram of an example of a power combiner that includes a conventional transformer design.

FIG. 2 includes graphs of magnetic coupling coefficients as a function of frequency for components of the power combiner illustrated in FIG. 1.

FIG. 3 includes diagrams that illustrate a theory underlying the disclosure.

FIG. 4 is a diagram of an example of a transformer according to the disclosure.

FIG. 5 is a diagram of an example of an array that includes several of the transformers illustrated in FIG. 4.

FIG. 6 is a diagram of an example of a power combiner that includes several of the transformers illustrated in FIG. 4.

FIG. 7 includes graphs of magnetic coupling coefficients as a function of frequency for components of the power combiner illustrated in FIG. 6.

FIG. 8 is a diagram of an example of a circuit that includes the power combiner illustrated in FIG. 6.

FIG. 9 is a diagram of an example of an array that includes a conventional transformer design.

FIG. 10 is a diagram of an example of an array that includes several of the transformers illustrated in FIG. 4.

FIG. 11 includes a graph of degrees of near field isolation as a function of frequency for the arrays illustrated in FIGS. 9 and 10.

FIG. 12 is a diagram of an example of a first circuit that includes the array illustrated in FIG. 10.

FIG. 13 is a diagram of an example of a second circuit that includes the array illustrated in FIG. 10.

FIG. 14 is a diagram of an example of a power splitter that includes several of the transformers illustrated in FIG. 4.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Aspects of this disclosure generally relate to a transformer in which each of a first conductor and a second conductor has a shape that resembles a symbol for the number eight (i.e., 8) and the second conductor is disposed between a first section of the first conductor and a second section of the first conductor.

The reduction in feature sizes of active devices has enabled more of them to be fabricated on an integrated circuit chip. This evolution has made area on a chip available to accommodate the fabrication of more complex circuits that include both active and passive devices even though some passive devices, for example, inductors and transformers, must be spaced sufficiently apart from one another to prevent problems associated with undesired magnetic coupling between them. More recently, technology standards for wireless networks, in order to increase data rates, have adopted an approach known as carrier (or channel) aggregation in which data is transmitted over several channels. Implementations of this approach can require equipment that uses several transceivers and power amplifiers, which in turn can involve the use of several transformers. The increase in the need for on-chip transformers, and the area these devices consume, presents a limitation on the number of devices that can be fabricated on a chip.

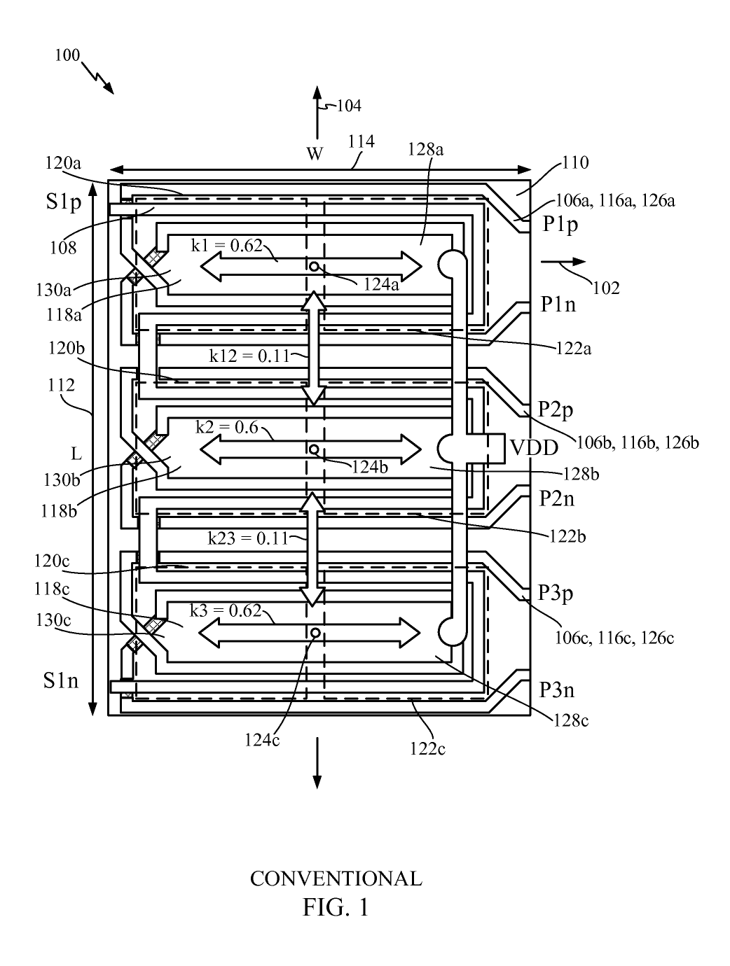

FIG. 1 is a diagram of an example of a power combiner 100 that includes a conventional transformer design. The power combiner 100 is disposed along a first axis 102 and a second axis 104. The power combiner 100 includes a plurality of first conductors 106a, 106b, and 106c and a second conductor 108. Each of the plurality of first conductors 106a, 106b, and 106c is adjacent to another of the plurality of first conductors 106a, 106b, and 106c along the second axis 104. An overall area 110 of the power combiner 100 is defined by a length 112 that has a first value L and a width 114 that has a second value W. For example, in an implementation, the first value L can be 1.08 mm and the second value W can be 0.875 mm. Each of the plurality of first conductors 106a, 106b, and 106c has a corresponding first section 116a, 116b, and 116c to substantially enclose a corresponding area 118a, 118b, and 118c without crossing from a corresponding first side 120a, 120b, and 120c of the corresponding area 118a, 118b, and 118c to a corresponding second side 122a, 122b, and 122c of the corresponding area 118a, 118b, and 118c substantially at a corresponding center 124a, 124b, and 124c of the corresponding area 118a, 118b, and 118c. Each of the first sections 116a, 116b, and 116c has a corresponding single portion 126a, 126b, and 126c disposed to substantially enclose both a corresponding first area 128a, 128b, and 128c and a corresponding second area 130a, 130b, and 130c.

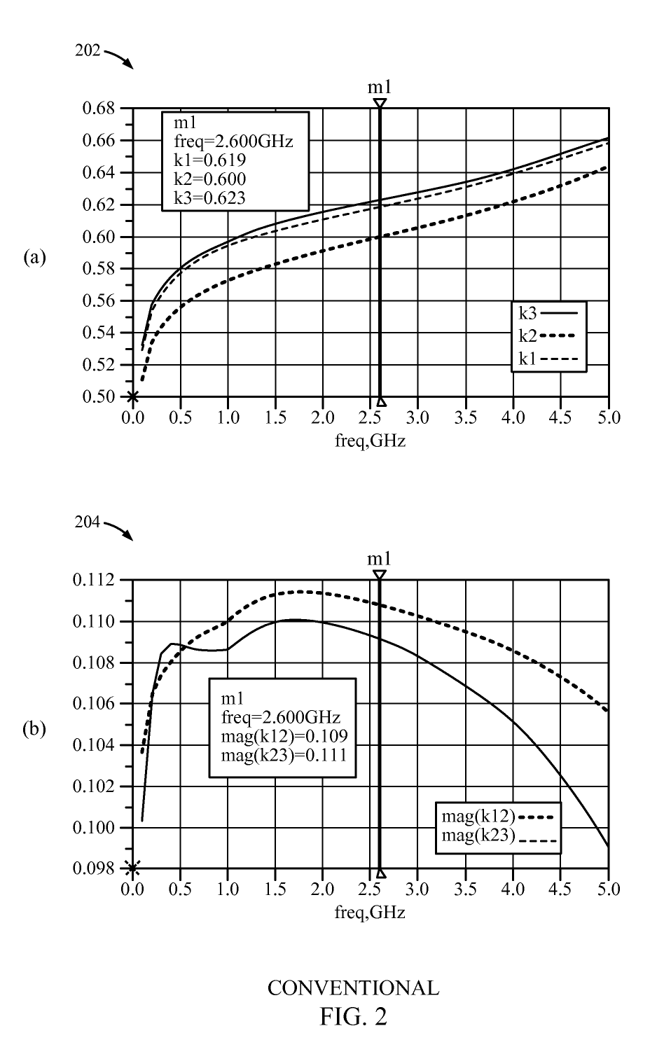

FIG. 2 includes graphs 202 and 204 of magnetic coupling coefficients as a function of frequency for components of the power combiner 100.

A view (a) of FIG. 2 is the graph 202 of magnetic coupling coefficients k₁, k₂, and k₃ between the second conductor 108 of the power combiner 100 and each of the plurality of first conductors 106a, 106b, and 106c of the power combiner 100 as a function of frequency. The graph 202 illustrates that magnetic coupling between the second conductor 108 and each of the plurality of first conductors 106a, 106b, and 106c is strong.

A view (b) of FIG. 2 is the graph 204 of a magnetic coupling coefficient k₁₂ between the first first conductor 106a of the power combiner 100 and the second first conductor 106b of the power combiner 100 as a function of frequency and a magnetic coupling coefficient k₂₃ between the second first conductor 106b of the power combiner 100 and the third first conductor 106c of the power combiner 100 as a function of frequency. The graph 204 illustrates that isolation between each of the plurality of first conductors 106a, 106b, and 106c and an adjacent one of the plurality of first conductors 106a, 106b, and 106c is poor.

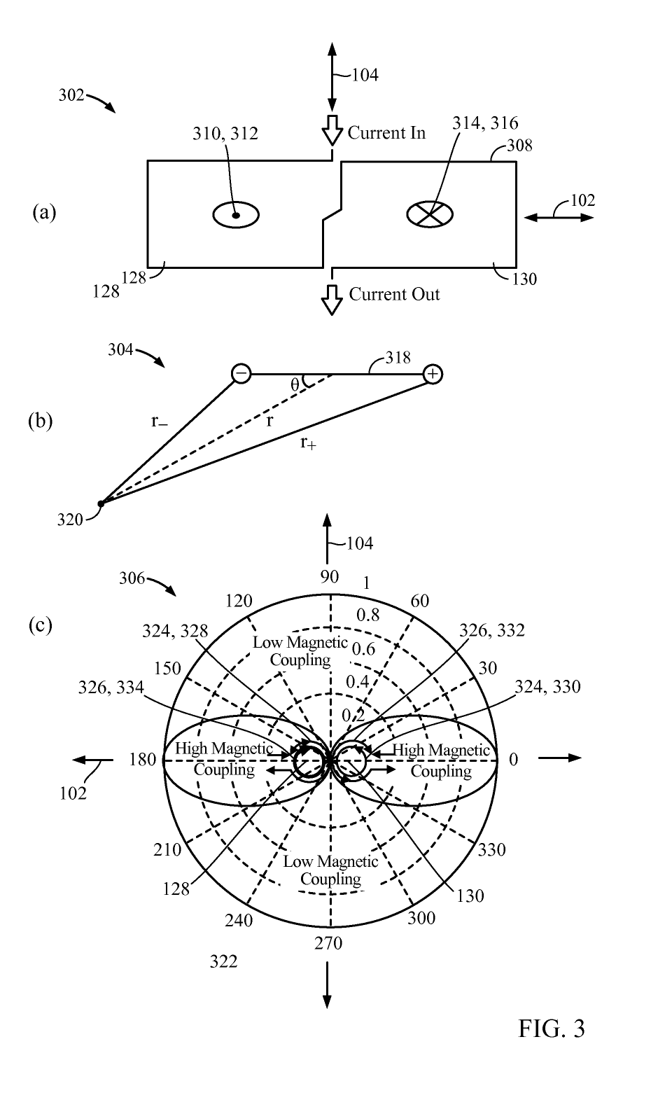

FIG. 3 includes diagrams 302, 304, and 306 that illustrate a theory underlying the disclosure.

A view (a) of FIG. 3 is the diagram 302 of an example of a conductor 308 used in a transformer design according to the disclosure. The conductor 308 can have a shape that resembles a symbol for the number eight (i.e., 8). Sides of the shape can be straight, curved, or a combination of both. A current that flows through the conductor 308 can produce a first magnetic field 310 that has a first direction 312 in the first area 128 and a second magnetic field 314 that has a second direction 316 in the second area 130. For example, the first direction 312 can be perpendicular and into a plane of the first area 128 and the second direction 316 can be perpendicular and out of a plane of the second area 130. For this reason, a structure of the conductor 308 can resemble a dipole 318.

A view (b) of FIG. 3 is the diagram 304 that illustrates a calculation of a strength of a magnetic field, produced by the dipole 318, at a point P 320. The strength of the magnetic field B can be expressed as:

B˜constant×[cos(θ)/r²].

Using this expression, the inventors discovered that the conductor 308 produced a strong magnetic field B along the first axis 102, but a weak magnetic field B along the second axis 104 and further discovered that magnetic coupling between the conductor 308 and another similarly configured conductor (not illustrated) disposed adjacent to the conductor 308 along the second axis 104 is minimal. In other words, the inventors discovered that near field isolation between the conductor 308 and another similarly configured conductor (not illustrated) disposed adjacent to the conductor 308 along the second axis 104 is strong.

A view (c) of FIG. 3 is the diagram 306 of a graph of a normalized distribution of the magnetic field produced by a transformer 322. The transformer 322 can include a first conductor 324 and a second conductor 326. The first conductor 324 can have a first portion 328 and a second portion 330. The second conductor 326 can have a third portion 332 and a fourth portion 334. The first portion 328 can be disposed to substantially enclose the first area 128. The third portion 332 can be disposed to substantially enclose the second area 130. The second portion 330 can be disposed within the first area 128. The fourth portion 334 can be disposed within the second area 130. The first conductor 324 can have a shape that resembles a symbol for the number eight (i.e., 8). The second conductor 326 can have a shape that resembles a symbol for the number eight (i.e., 8). The normalized distribution of the magnetic field produced by the transformer 322 can be expressed as a first order Taylor expansion of a Biot Savar integral that has the form:

$$[ \frac{1}{{r}_{1}} + \frac{1}{j {kr}_{1}^{2}} - \frac{1}{{k}^{2} {r}_{1}^{3}} ] {e}^{- j {kr}_{1}} - [ \frac{1}{{r}_{2 }} + \frac{1}{j {kr}_{2}^{2}} - \frac{1}{{k}^{2} {r}_{2 }^{3}} ] {e}^{- j {kr}_{2}} .$$

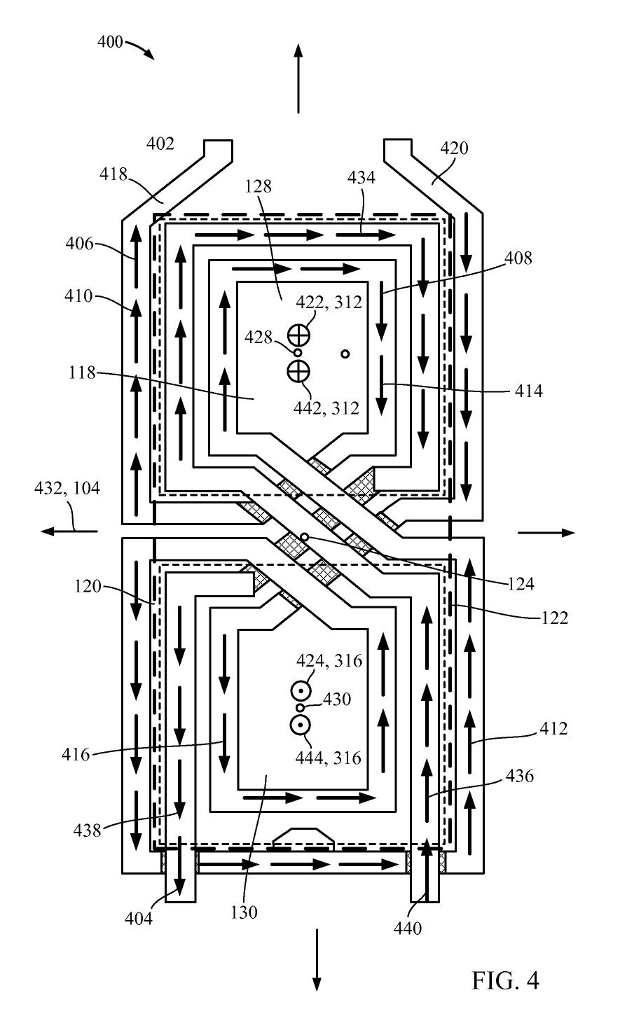

FIG. 4 is a diagram of an example of a transformer 400 according to the disclosure. The transformer 400 can include a first conductor 402 and a second conductor 404. The transformer 400 can be configured to isolate a direct current component voltage of a first circuit (not illustrated) from a direct current component voltage of a second circuit (not illustrated), step-up or step-down a voltage of the first circuit for use as a voltage of the second circuit, step-up or step-down a current of the first circuit for use as a current of the second circuit, match an impedance between the first circuit and the second circuit, other functions known to those of skill in the art, or a combination of the foregoing.

The first conductor 402 can have a first section 406 and a second section 408. The first section 406 can be disposed to substantially enclose the area 118 and to cross from the first side 120 of the area 118 to the second side 122 of the area 118 substantially at the center 124 of the area 118. The first section 406 can have a first portion 410 and a third portion 412. The first portion 410 can be disposed to substantially enclose the first area 128. The third portion 412 can be disposed to substantially enclose the second area 130. The second area 130 can lack an intersection with the first area 128. The second section 408 can be disposed within the area 118 and to cross from the first side 120 to the second side 122 substantially at the center 124. The second section 408 can have a second portion 414 and a fourth portion 416. The second portion 414 can be disposed within the first area 128. The fourth portion 416 can be disposed within the second area 130. The first portion 410 can have a first part 418 and a second part 420. The second portion 414 can be connected between the third portion 412 and the first part 418. The fourth portion 416 can be connected between the third portion 412 and the second part 420.

The first conductor 402 can have a shape that resembles a symbol for the number eight (i.e., 8). Sides of the shape can be straight, curved, or a combination of both. The first conductor 402 can be configured so that a current that flows through the first conductor 402 in a direction indicated by the arrows produces a first magnetic field 422 that has the first direction 312 in the first area 128 and a second magnetic field 424 that has the second direction 316 in the second area 130. For example, the first direction 312 can be perpendicular and into the plane of the first area 128 and the second direction 316 can be perpendicular and out of the plane of the second area 130. A first line 426 between a center 428 of the first area 128 and a center 430 of the second area 130 defines the first axis 102 and a second line 432 that bisects the transformer 400 and is perpendicular to the first line 426 defines the second axis 104.

The second conductor 404 can be disposed between the first section 406 and the second section 408 and to cross from the first side 120 to the second side 122 substantially at the center 124. (Because the second conductor 404 can be disposed between the first section 406 and the second section 408, the transformer 400 can be referred to as being interleaved.) The second conductor 404 can have a fifth portion 434 and a sixth portion 436. The fifth portion 434 can be disposed between the first portion 410 and the second portion 414. The sixth portion 436 can be disposed between the third portion 412 and the fourth portion 416. The sixth portion 436 can have a first part 438 and a second part 440. The fifth portion 434 can be connected between the first part 438 and the second part 440.

The second conductor 404 can have a shape that resembles the symbol for the number eight (i.e., 8). The sides of the shape can be straight, curved, or a combination of both. The second conductor 404 can be configured so that a current that flows through the second conductor 404 in a direction indicated by the arrows produces a third magnetic field 442 that has the first direction 312 in the first area 128 and a fourth magnetic field 444 that has the second direction 316 in the second area 130. For example, the first direction 312 can be perpendicular and into the plane of the first area 128 and the second direction 316 can be perpendicular and out of the plane of the second area 130. The second conductor 404 can be configured to be magnetically coupled to the first conductor 402.

The distribution of the magnetic field produced by the transformer 400 can be similar to the distribution of the magnetic field produced by the transformer 322 illustrated at the view (c) of FIG. 3.

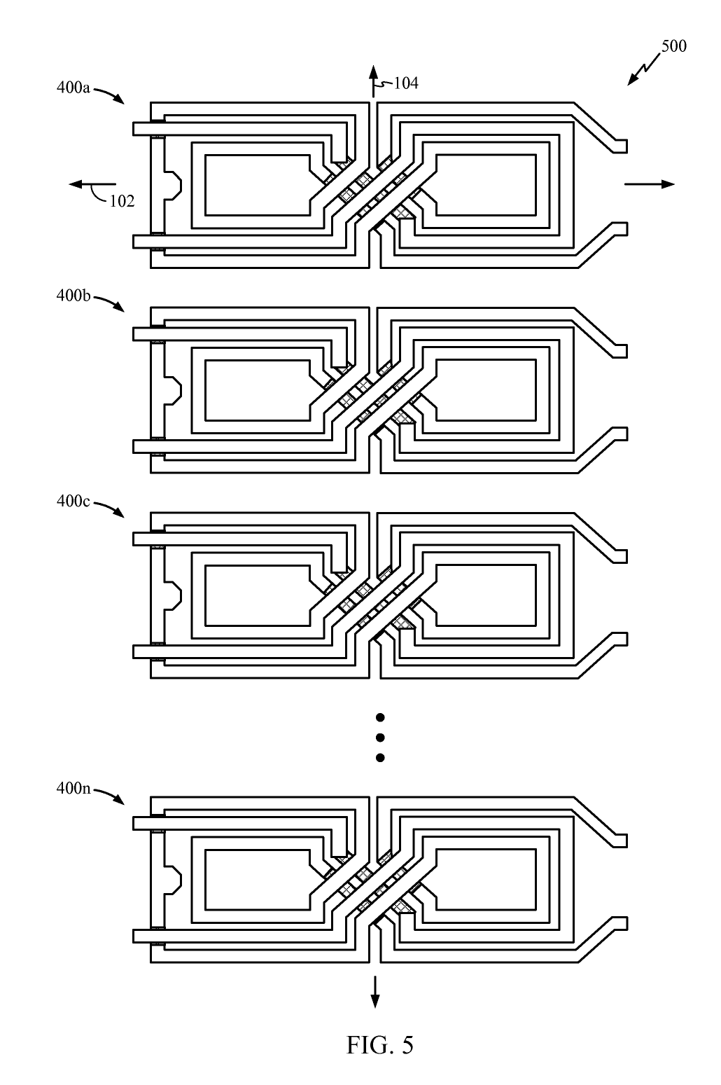

FIG. 5 is a diagram of an example of an array 500 that includes several of the transformers 400. The array 500 can include transformers 400a, 400b, 400c, . . . , 400n. Each of the transformers 400a, 400b, 400c, . . . , 400n is disposed adjacent to another of the transformers 400a, 400b, 400c, . . . , 400n along the second axis 104. Coupling between each of the transformers 400a, 400b, 400c, . . . , 400n and each adjacent other of the transformers 400a, 400b, 400c, . . . , 400n can be minimal In other words, near field isolation between each of the transformers 400a, 400b, 400c, . . . , 400n and each adjacent other of the transformers 400a, 400b, 400c, . . . , 400n can be strong.

Advantageously, the transformers 400a, 400b, 400c, . . . , 400n of the array 500 can be spaced closer to one another than can the conventional transformers of the power combiner 100.

Advantageously, this can facilitate a reduction in a size of an integrated circuit chip.

Advantageously, for a given size of an integrated circuit chip, this can make more area available on the chip to accommodate the fabrication of more complex circuits.

Advantageously, this can reduce a degree of complexity in routing signals on a chip, which in turn can reduce performance degradation due to magnetic coupling that can occur among signals.

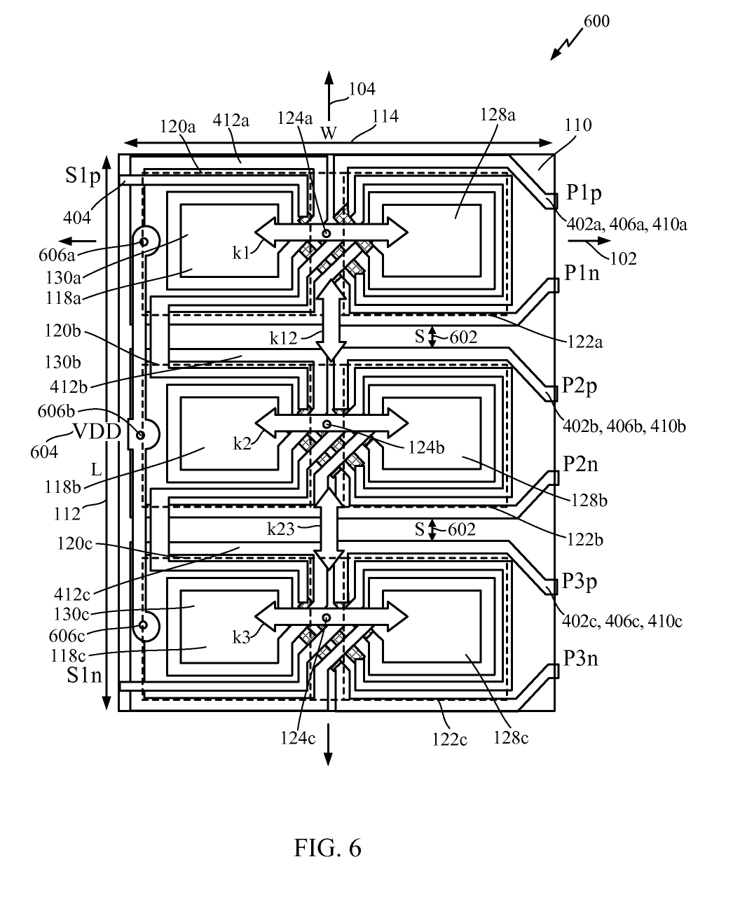

FIG. 6 is a diagram of an example of a power combiner 600 that includes several of the transformers 400. The power combiner 600 can be disposed along the first axis 102 and the second axis 104. The power combiner 600 can include a plurality of the first conductors 402a, 402b, and 402c and the second conductor 404. Each of the plurality of the first conductors 402a, 402b, and 402c can be adjacent to another of the plurality of the first conductors 402a, 402b, and 402c along the second axis 104. Each of the plurality of the first conductors 402a, 402b, and 402c can be separated from another of the plurality of the first conductors 402a, 402b, and 402c along the second axis 104 by a space 602 that has a third value S. For example, in an implementation, the third value S can be 0.45 μm. The overall area 110 of the power combiner 600 can be defined by the length 112 that has the first value L and the width 114 that has the second value W. For example, in an implementation, the first value L can be 1.08 mm and the second value W can be 0.875 mm.

Each of the plurality of the first conductors 402a, 402b, and 402c can have the corresponding first section 406a, 406b, and 406c to substantially enclose the corresponding area 118a, 118b, and 118c and to cross from the corresponding first side 120a, 120b, and 120c of the corresponding area 118a, 118b, and 118c to the corresponding second side 122a, 122b, and 122c of the corresponding area 118a, 118b, and 118c substantially at the corresponding center 124a, 124b, and 124c of the corresponding area 118a, 118b, and 118c. Each of the first sections 406a, 406b, and 406c can have the corresponding first portion 410a, 410b, and 410c and the corresponding third portion 412a, 412b, and 412c. Each of the first portions 410a, 410b, and 410c can be disposed to enclose the corresponding first area 128a, 128b, and 128c. Each of the third portions 412a, 412b, and 412c can be disposed to enclose the corresponding second area 130a, 130b, and 130c.

Each of the plurality of the first conductors 402a, 402b, and 402c can be configured to receive a supply voltage 604. For example, the first of the plurality of the first conductors 402a can be configured to receive the supply voltage 604 at a center 606a of the first of the plurality of the first conductors 402a. For example, the second of the plurality of the first conductors 402b can be configured to receive the supply voltage 604 at a center 606b of the second of the plurality of the first conductors 402b. For example, the third of the plurality of the first conductors 402c can be configured to receive the supply voltage 604 at a center 606c of the third of the plurality of the first conductors 402c. Such a configuration can be used, for example, to achieve load balance for a differential amplifier. A single ended amplifier can be implemented without such a configuration.

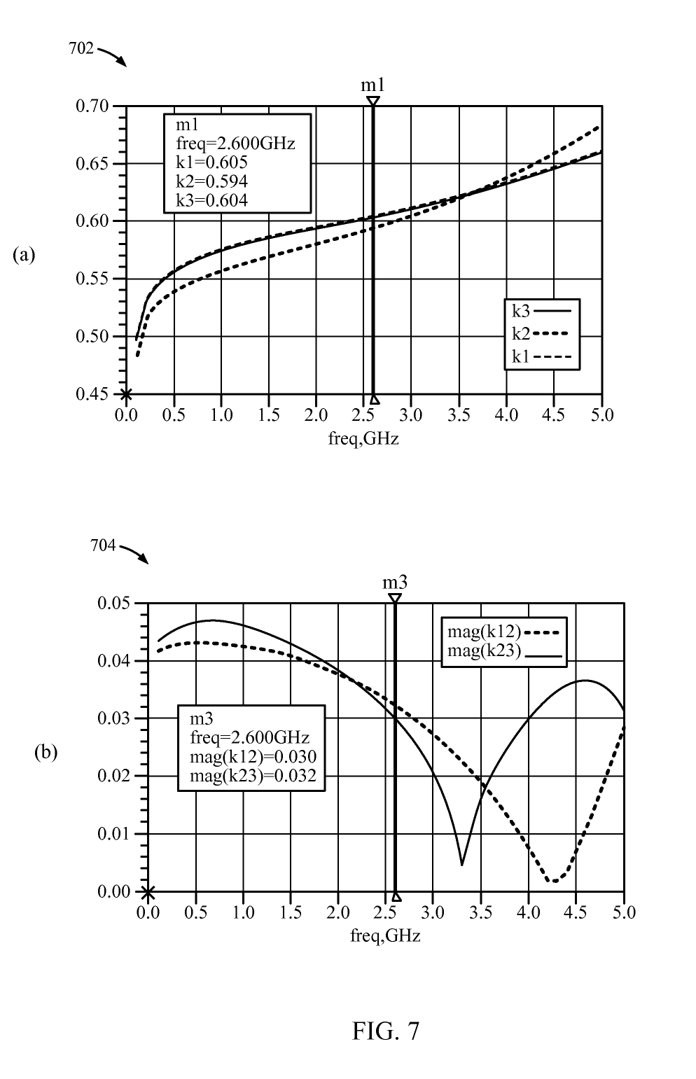

FIG. 7 includes graphs 702 and 704 of magnetic coupling coefficients as a function of frequency for components of the power combiner 600.

A view (a) of FIG. 7 is the graph 702 of each of the magnetic coupling coefficients k1, k2, and k3 as a function of frequency. The magnetic coupling coefficient k1 is for the magnetic coupling between the first conductor 402a of the power combiner 600 and the second conductor 404 of the power combiner 600. The magnetic coupling coefficient k2 is for the magnetic coupling between the first conductor 402b of the power combiner 600 and the second conductor 404 of the power combiner 600. The magnetic coupling coefficient k3 is for the magnetic coupling between the first conductor 402c of the power combiner 600 and the second conductor 404 of the power combiner 600. The graph 702 illustrates that magnetic coupling between the second conductor 404 and each of the plurality of the first conductors 402a, 402b, and 402c is strong.

A view (b) of FIG. 7 is the graph 704 of the magnetic coupling coefficient k12 and k23 as a function of frequency. The magnetic coupling coefficient k12 is for the magnetic coupling between the first first conductor 402a of the power combiner 600 and the second first conductor 402b of the power combiner 600. The magnetic coupling coefficient k23 is for the magnetic coupling between the second first conductor 402b of the power combiner 600 and the third first conductor 402c of the power combiner 600. The graph 704 illustrates that isolation between each of the plurality of the first conductors 402a, 402b, and 402c and an adjacent one of the plurality of the first conductors 402a, 402b, and 402c is strong.

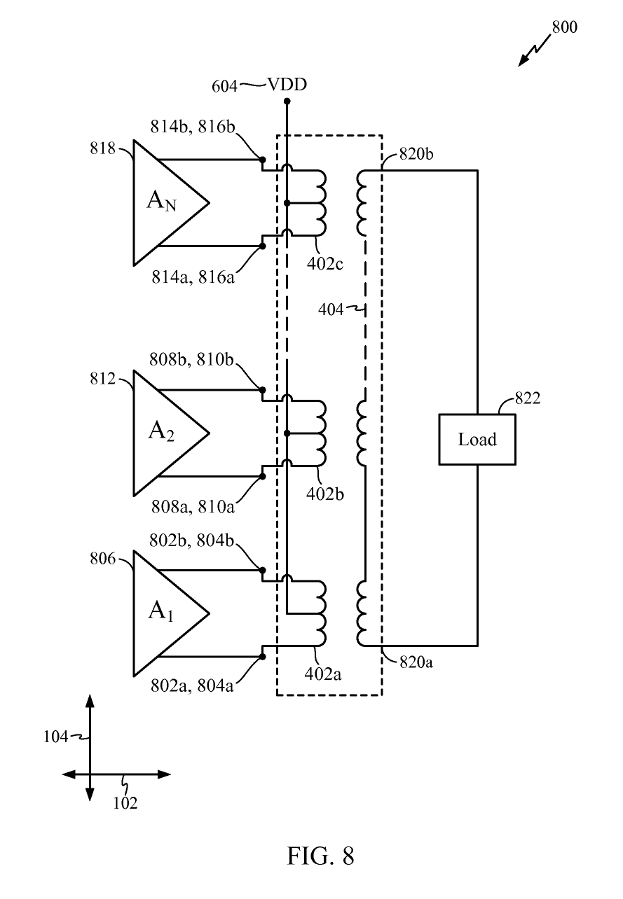

FIG. 8 is a diagram of an example of a circuit 800 that includes the power combiner 600. The circuit 800 can be disposed along the first axis 102 and the second axis 104. A pair of inputs 802a and 802b to the first of the plurality of first conductors 402a can be connected to a pair of outputs 804a and 804b from a first amplifier 806. A pair of inputs 808a and 808b to the second of the plurality of first conductors 402b can be connected to a pair of outputs 810a and 810b from a second amplifier 812. A pair of inputs 814a and 814b to the third of the plurality of first conductors 402c can be connected to a pair of outputs 816a and 816b from a third amplifier 818. A pair of outputs 820a and 820b from the second conductor 404 can be connected to a load 822. The load 822 can include, for example, a switched network, an antenna load circuitry, a fourth amplifier, the like, or a combination of the foregoing.

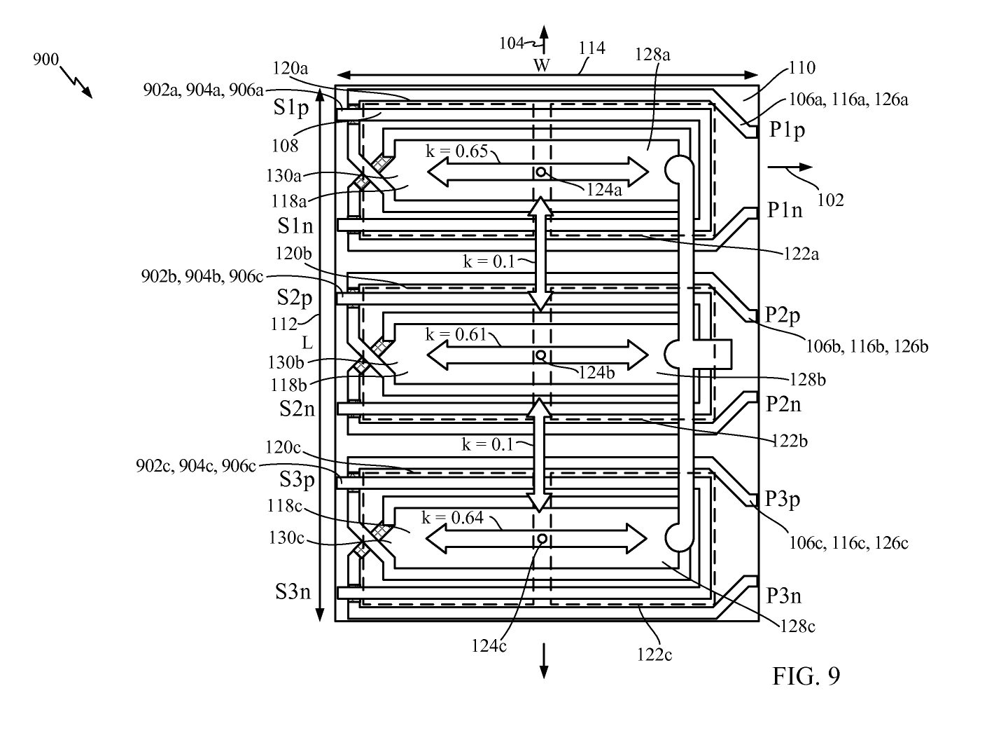

FIG. 9 is a diagram of an example of an array 900 that includes a conventional transformer design. The array 900 is disposed along the first axis 102 and the second axis 104. The array 900 includes the plurality of first conductors 106a, 106b, and 106c and a plurality of second conductors 902a, 902b, and 902c. Each of the plurality of first conductors 106a, 106b, and 106c is adjacent to another of the plurality of first conductors 106a, 106b, and 106c along the second axis 104. Each of the plurality of second conductors 902a, 902b, and 902c is adjacent to another of the plurality of second conductors 902a, 902b, and 902c along the second axis 104. The overall area 110 of the array 900 is defined by the length 112 that has the first value L and the width 114 that has the second value W. For example, in an implementation, the first value L can be 1.08 mm and the second value W can be 0.875 mm. Each of the plurality of first conductors 106a, 106b, and 106c has the corresponding first section 116a, 116b, and 116c to substantially enclose the corresponding area 118a, 118b, and 118c without crossing from the corresponding first side 120a, 120b, and 120c of the corresponding area 118a, 118b, and 118c to the corresponding second side 122a, 122b, and 122c of the corresponding area 118a, 118b, and 118c substantially at the corresponding center 124a, 124b, and 124c of the corresponding area 118a, 118b, and 118c. Each of the first sections 116a, 116b, and 116c has the corresponding single portion 126a, 126b, and 126c disposed to substantially enclose both the corresponding first area 128a, 128b, and 128c and the corresponding second area 130a, 130b, and 130c. Each of the plurality of second conductors 902a, 902b, and 902c has a corresponding first section 904a, 904b, and 904c to substantially enclose the corresponding area 118a, 118b, and 118c without crossing from the corresponding first side 120a, 120b, and 120c of the corresponding area 118a, 118b, and 118c to the corresponding second side 122a, 122b, and 122c of the corresponding area 118a, 118b, and 118c substantially at the corresponding center 124a, 124b, and 124c of the corresponding area 118a, 118b, and 118c. Each of the first sections 904a, 904b, and 904c has a corresponding single portion 906a, 906b, and 906c disposed within both the corresponding first area 128a, 128b, and 128c and the corresponding second area 130a, 130b, and 130c.

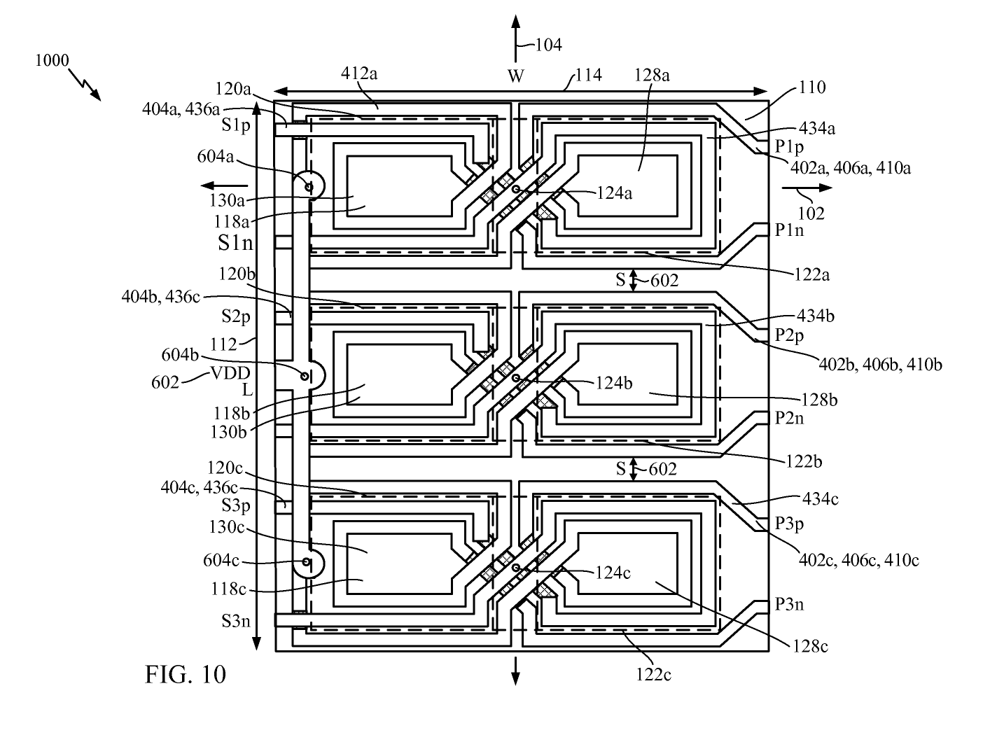

FIG. 10 is a diagram of an example of an array 1000 that includes several of the transformers 400. The array 1000 can be disposed along the first axis 102 and the second axis 104. The array 1000 can include the plurality of the first conductors 402a, 402b, and 402c and a plurality of second conductors 404a, 404b, and 404c. Each of the plurality of the first conductors 402a, 402b, and 402c can be adjacent to another of the plurality of the first conductors 402a, 402b, and 402c along the second axis 104. Each of the plurality of the first conductors 402a, 402b, and 402c can be separated from another of the plurality of the first conductors 402a, 402b, and 402c along the second axis 104 by the space 602 that has the third value S. For example, in an implementation, the third value S can be 0.45 μm. The overall area 110 of the array 1000 can be defined by the length 112 that has the first value L and the width 114 that has the second value W. For example, in an implementation, the first value L can be 1.08 mm and the second value W can be 0.875 mm.

Each of the plurality of the first conductors 402a, 402b, and 402c can have the corresponding first section 406a, 406b, and 406c to substantially enclose the corresponding area 118a, 118b, and 118c and to cross from the corresponding first side 120a, 120b, and 120c of the corresponding area 118a, 118b, and 118c to the corresponding second side 122a, 122b, and 122c of the corresponding area 118a, 118b, and 118c substantially at the corresponding center 124a, 124b, and 124c of the corresponding area 118a, 118b, and 118c. Each of the first sections 406a, 406b, and 406c can have the corresponding first portion 410a, 410b, and 410c and the corresponding third portion 412a, 412b, and 412c. Each of the first portions 410a, 410b, and 410c can be disposed to enclose the corresponding first area 128a, 128b, and 128c. Each of the second portions 412a, 412b, and 412c can be disposed to enclose the corresponding second area 130a, 130b, and 130c.

Each of the plurality of the first conductors 402a, 402b, and 402c can be configured to receive the supply voltage 604. For example, the first of the plurality of the first conductors 402a can be configured to receive the supply voltage 604 at the center 606a of the first of the plurality of the first conductors 402a. For example, the second of the plurality of the first conductors 402b can be configured to receive the supply voltage 604 at the center 606b of the second of the plurality of the first conductors 402b. For example, the third of the plurality of the first conductors 402c can be configured to receive the supply voltage 604 at the center 606c of the third of the plurality of the first conductors 402c. Such a configuration can be used, for example, to achieve load balance for a differential amplifier. A single ended amplifier can be implemented without such a configuration.

Each of the plurality of second conductors 404a, 404b, and 404c can be adjacent to another of the plurality of the second conductors 404a, 404b, and 404c along the second axis 104. Each of the plurality of second conductors 404a, 404b, and 404c can have the corresponding fifth portion 434a, 434b, and 434c and the corresponding sixth portion 436a, 436b, and 436c. Each of the fifth portions 434a, 434b, and 434c can be disposed substantially near external sides of the corresponding first area 128a, 128b, and 128c. Each of the sixth portions 436a, 436b, and 436c can be disposed substantially near external sides of the corresponding second area 130a, 130b, and 130c.

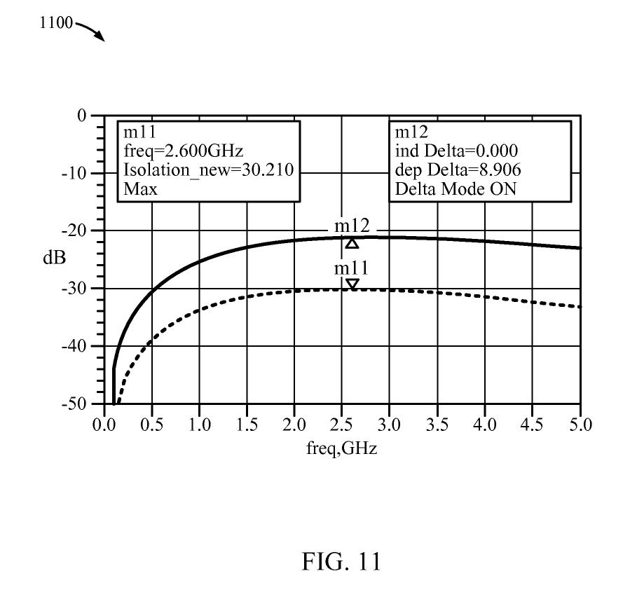

FIG. 11 includes a graph 1100 of degrees of near field isolation as a function of frequency for the array 900 and the array 1000. The graph 1100 illustrates that, for almost all frequencies, the degree of isolation m11 for the array 1000 is greater than the degree of isolation m12 for the array 900.

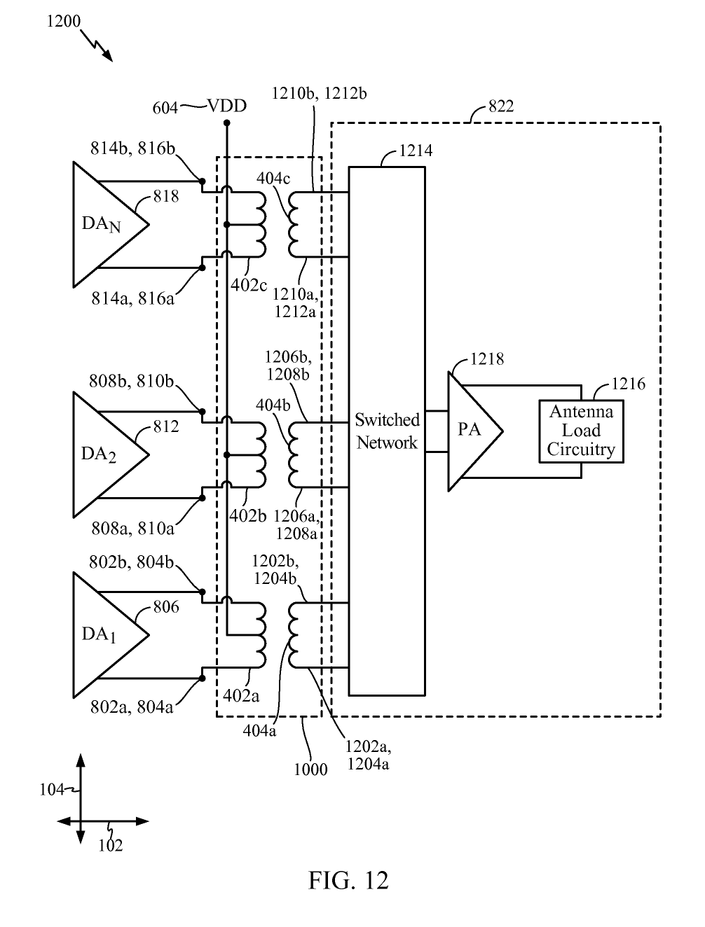

FIG. 12 is a diagram of an example of a first circuit 1200 that includes the array 1000. The first circuit 1200 can be disposed along the first axis 102 and the second axis 104. The pair of inputs 802a and 802b to the first of the plurality of first conductors 402a can be connected to the pair of outputs 804a and 804b from the first amplifier 806. The pair of inputs 808a and 808b to the second of the plurality of first conductors 402b can be connected to the pair of outputs 810a and 810b from the second amplifier 812. The pair of inputs 814a and 814b to the third of the plurality of first conductors 402c can be connected to the pair of outputs 816a and 816b from the third amplifier 818. A pair of outputs 1202a and 1202b from the first of the plurality of second conductors 404a can be connected to a pair of inputs 1204a and 1204b to the load 822. A pair of outputs 1206a and 1206b from the second of the plurality of second conductors 404b can be connected to a pair of inputs 1208a and 1208b to the load 822. A pair of outputs 1210a and 1210b from the third of the plurality of second conductors 404c can be connected to a pair of inputs 1212a and 1212b to the load 822. The load 822 can include, for example, a switched network 1214, an antenna load circuitry 1216, a fourth amplifier 1218, the like, or a combination of the foregoing.

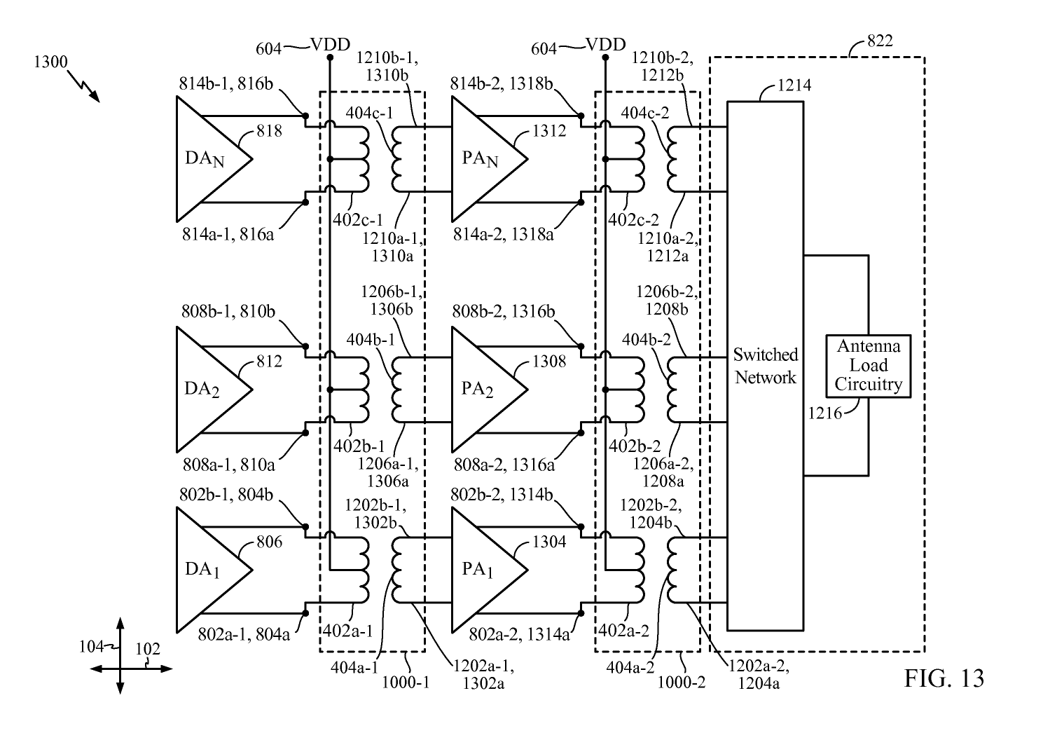

FIG. 13 is a diagram of an example of a second circuit 1300 that includes the array 1000. The second circuit 1300 can be disposed along the first axis 102 and the second axis 104. The second circuit 1300 can include a first of a plurality of stages of the plurality of first conductors and a first of a plurality of stages of the plurality of second conductors 1000-1 and a second of the plurality of stages of the plurality of first conductors and a second of the plurality of stages of the second conductors 1000-2.

The pair of inputs 802a-1 and 802b-1 to the first first conductor of the first of the plurality of stages of the plurality of first conductors 402a-1 can be connected to the pair of outputs 804a and 804b from the first amplifier 806. The pair of inputs 808a-1 and 808b-1 to the second first conductor of the first of the plurality of stages of the plurality of first conductors 402b-1 can be connected to the pair of outputs 810a and 810b from the second amplifier 812. The pair of inputs 814a-1 and 814b-1 to the third first conductor of the first of the plurality of stages of the plurality of first conductors 402c-1 can be connected to the pair of outputs 816a and 816b from the third amplifier 818. The pair of outputs 1202a-1 and 1202b-1 from the first second conductor of the first of the plurality of stages of the plurality of second conductors 404a-1 can be connected to a pair of inputs 1302a and 1302b to a fourth amplifier 1304. The pair of outputs 1206a-1 and 1206b-1 from the second second conductor of the first of the plurality of stages of the plurality of second conductors 404b-1 can be connected to a pair of inputs 1306a and 1306b to a fifth amplifier 1308. The pair of outputs 1210a-1 and 1210b-1 from the third second conductor of the first of the plurality of stages of the plurality of second conductors 404c-1 can be connected to a pair of inputs 1310a and 1310b to a sixth amplifier 1312.

The pair of inputs 802a-2 and 802b-2 to the first first conductor of the second of the plurality of stages of the plurality of first conductors 402a-2 can be connected to a pair of outputs 1314a and 1314b from the fourth amplifier 1304. The pair of inputs 808a-2 and 808b-2 to the second first conductor of the second of the plurality of stages of the plurality of first conductors 402b-2 can be connected to a pair of outputs 1316a and 1316b from the fifth amplifier 1308. The pair of inputs 814a-2 and 814b-2 to the third first conductor of the second of the plurality of stages of the plurality of first conductors 402c-2 can be connected to a pair of outputs 1318a and 1318b from the sixth amplifier 1312. The pair of outputs 1202a-2 and 1202b-2 from the first second conductor of the second of the plurality of stages of the plurality of second conductors 404a-2 can be connected to the pair of inputs 1204a and 1204b to the load 822. The pair of outputs 1206a-2 and 1206b-2 from the second second conductor of the second of the plurality of stages of the plurality of second conductors 404b-2 can be connected to the pair of inputs 1208a and 1208b to the load 822. The pair of outputs 1210a-2 and 1210b-2 from the third second conductor of the second of the plurality of stages of the plurality of second conductors 404c-2 can be connected to the pair of inputs 1212a and 1212b to the load 822. The load 822 can include, for example, the switched network 1214, the antenna load circuitry 1216, a seventh amplifier, the like, or a combination of the foregoing.

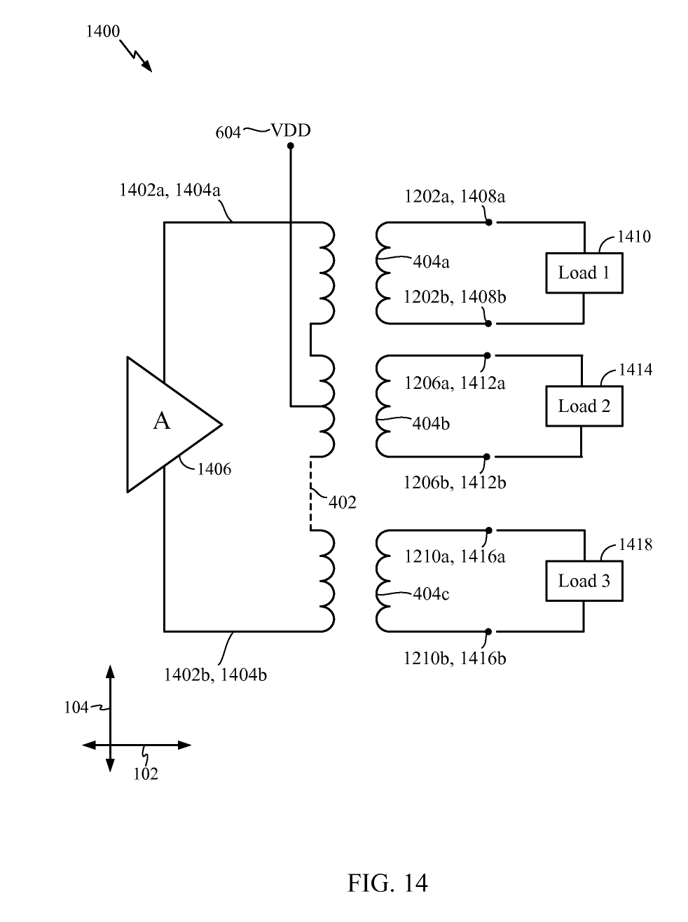

FIG. 14 is a diagram of an example of a power splitter 1400 that includes several of the transformers 400. The power splitter 1400 can be disposed along the first axis 102 and the second axis 104. A pair of inputs 1402a and 1402b to the first conductor 402 can be connected to a pair of outputs 1404a and 1404b from a first amplifier 1406. The pair of outputs 1202a and 1202b from the first of the plurality of second conductors 404a can be connected to a pair of inputs 1408a and 1408b to a first load 1410. The pair of outputs 1206a and 1206b from the second of the plurality of second conductors 404b can be connected to a pair of inputs 1412a and 1412b to a second load 1414. The pair of outputs 1210a and 1210b from the third of the plurality of second conductors 404c can be connected to a pair of inputs 1416a and 1416b to a third load 1418. At least one of the first load 1410, the second load 1414, or the third load 1418 can include, for example, a switched network, an antenna load circuitry, a second amplifier, the like, or a combination of the foregoing.

While the foregoing disclosure describes various illustrative aspects, it is noted that various changes and modifications may be made to the illustrated examples without departing from the scope defined by the appended claims. The present disclosure is not intended to be limited to the specifically illustrated examples alone. For example, although certain aspects may be described or claimed in the singular, the plural is contemplated unless limitation to the singular is explicitly stated.

What is claimed is:

1. An apparatus configured to isolate a direct current component voltage of a first circuit from a direct current component voltage of a second circuit, comprising:
a first conductor having a first portion disposed to substantially enclose a first area, a second portion disposed within the first area, a third portion disposed to substantially enclose a second area, and a fourth portion disposed within the second area, the second area lacking an intersection with the first area; and
a second conductor configured to be magnetically coupled to the first conductor and having a fifth portion disposed between the first portion and the second portion and a sixth portion disposed between the third portion and the fourth portion.

2. The apparatus of claim 1, wherein the second portion is connected between the third portion and a first part of the first portion and the fourth portion is connected between the third portion and a second part of the first portion.

3. The apparatus of claim 2, wherein the first conductor has a shape that resembles a symbol for the number eight.

4. The apparatus of claim 3, wherein sides of the shape are at least one of straight or curved.

5. The apparatus of claim 2, wherein the fifth portion is connected between a first part of the sixth portion and a second part of the sixth portion.

6. The apparatus of claim 5, wherein the second conductor has a shape that resembles a symbol for the number eight.

7. The apparatus of claim 6, wherein sides of the shape are at least one of straight or curved.

8. The apparatus of claim 1, wherein a first line between a center of the first area and a center of the second area defines a first axis, a second line that bisects the apparatus and is perpendicular to the first line defines a second axis, the first conductor comprises a plurality of first conductors, and a first of the plurality of first conductors is disposed adjacent to a second of the plurality of first conductors along the second axis.

9. The apparatus of claim 8, wherein an overall area of the apparatus is defined by a length having a first value and a width having a second value and a degree of near field isolation between the first of the plurality of first conductors of the apparatus and the second of the plurality of first conductors of the apparatus is greater than a degree of near field isolation between a corresponding first of a plurality of first conductors of a different apparatus and a corresponding second of the plurality of first conductors of the different apparatus in which the overall area of the different apparatus is defined by the length having the first value and the width having the second value, but in which each of the plurality of first conductors of the different apparatus has a single portion disposed to substantially enclose both a corresponding first area and a corresponding second area.

10. The apparatus of claim 8, wherein the first of the plurality of first conductors is configured to receive a supply voltage and the second of the plurality of first conductors is configured to receive the supply voltage.

11. The apparatus of claim 10, wherein the first of the plurality of first conductors is configured to receive the supply voltage at a center of the first of the plurality of first conductors and the second of the plurality of first conductors is configured to receive the supply voltage at a center of the second of the plurality of first conductors.

12. The apparatus of claim 8, wherein a pair of inputs to the first of the plurality of first conductors is connected to a pair of outputs from a first amplifier and a pair of inputs to the second of the plurality of first conductors is connected to a pair of outputs from a second amplifier.

13. The apparatus of claim 12, wherein a pair of outputs from the second conductor is connected to a load.

14. The apparatus of claim 13, wherein the load includes at least one of a switched network, an antenna load circuitry, or a third amplifier.

15. The apparatus of claim 12, wherein the second conductor comprises a plurality of second conductors and a first of the plurality of second conductors is disposed adjacent to a second of the plurality of second conductors along the second axis.

16. The apparatus of claim 15, wherein a pair of outputs from the first of the plurality of second conductors is connected to a load and a pair of outputs from the second of the plurality of second conductors is connected to the load.

17. The apparatus of claim 16, wherein the load includes at least one of a switched network, an antenna load circuitry, or a third amplifier.

18. The apparatus of claim 15, wherein the plurality of first conductors comprises a plurality of stages of the plurality of first conductors, the plurality of second conductors comprises a plurality of stages of the plurality of second conductors, a first of the plurality of stages of the plurality of first conductors is disposed adjacent to a second of the plurality of stages of the plurality of first conductors along the first axis, and a first of the plurality of stages of the plurality of second conductors is disposed adjacent to a second of the plurality of stages of the plurality of second conductors along the first axis.

19. The apparatus of claim 18, wherein a pair of outputs from a first second conductor of the first of the plurality of stages of the plurality of second conductors is connected to a pair of inputs to a third amplifier and a pair of outputs from a second second conductor of the first of the plurality of stages of the plurality of second conductors is connected to a pair of inputs to a fourth amplifier.

20. The apparatus of claim 19, wherein a pair of inputs to a first first conductor of the second of the plurality of stages of the plurality of first conductors is connected to a pair of outputs from the second amplifier and a pair of inputs to a second first conductor of the second of the plurality of stages of the plurality of first conductors is connected to a pair of outputs from the fourth amplifier.

21. The apparatus of claim 20, wherein a pair of outputs from a first second conductor of the second of the plurality of stages of the plurality of second conductors is connected to a load and a pair of outputs from a second second conductor of the second of the plurality of stages of the plurality of second conductors is connected to the load.

22. The apparatus of claim 21, wherein the load includes at least one of a switched network, an antenna load circuitry, or a fifth amplifier.

23. The apparatus of claim 1, wherein a first line between a center of the first area and a center of the second area defines a first axis, a second line that bisects the apparatus and is perpendicular to the first line defines a second axis, the second conductor comprises a plurality of second conductors, and a first of the plurality of second conductors is disposed adjacent to a second of the plurality of second conductors along the second axis.

24. The apparatus of claim 23, wherein an overall area of the apparatus is defined by a length having a first value and a width having a second value and a degree of near field isolation between the first of the plurality of second conductors of the apparatus and the second of the plurality of second conductors of the apparatus is greater than a degree of near field isolation between a corresponding first of a plurality of second conductors of a different apparatus and a corresponding second of the plurality of second conductors of the different apparatus in which the overall area of the different apparatus is defined by the length having the first value and the width having the second value, but in which each of the plurality of second conductors of the different apparatus has a single portion disposed substantially near external sides of both a corresponding first area and a corresponding second area.

25. The apparatus of claim 23, wherein a pair of inputs to the first conductor is connected to a pair of outputs from an amplifier.

26. The apparatus of claim 25, wherein a pair of outputs from the first of the plurality of second conductors is connected to a first load and a pair of outputs from the second of the plurality of second conductors is connected to a second load.

27. The apparatus of claim 26, wherein at least one of the first load or the second load includes at least one of a switched network, an antenna load circuitry, or an amplifier.

28. An apparatus configured to isolate a direct current component voltage of a first circuit from a direct current component voltage of a second circuit, comprising:
a first conductor having a first portion disposed to substantially enclose a first area, a second portion disposed within the first area, a third portion disposed to substantially enclose a second area, and a fourth portion disposed within the second area, the second area lacking an intersection with the first area, and configured so that a current that flows through the first conductor produces a first magnetic field having a first direction in the first area and a second magnetic field having a second direction in the second area; and
a second conductor configured to be magnetically coupled to the first conductor.

29. An apparatus configured to isolate a direct current component voltage of a first circuit from a direct current component voltage of a second circuit, comprising:
a first conductor having a first portion disposed to substantially enclose a first area, a second portion disposed within the first area, a third portion disposed to substantially enclose a second area, and a fourth portion disposed within the second area, the second area lacking an intersection with the first area; and
a second conductor configured to be magnetically coupled to the first conductor and configured so that a current that flows through the second conductor produces a first magnetic field having a first direction in the first area and a second magnetic field having a second direction in the second area.

30. An apparatus configured to isolate a direct current component voltage of a first circuit from a direct current component voltage of a second circuit, comprising:
a first conductor having a first section disposed to substantially enclose an area and to cross from a first side of the area to a second side of the area substantially at a center of the area and a second section disposed within the area and to cross from the first side to the second side substantially at the center; and
a second conductor disposed between the first section and the second section and to cross from the first side to the second side substantially at the center and configured to be magnetically coupled to the first conductor.
